(19) United States
(12) Patent Application Publication
(10) Pub. No.: US 2013/0144247 A1
(43) Pub. Date: Jun. 6, 2013

(54) BIOLOGIC STORAGE BAG MODIFICATIONS FACILITATING SAMPLE EXTRACTION AND UNIT SUBDIVISION

(71) Applicants: Robertson Davenport, Ann Arbor, MI (US); Michael Tarasev, Pinckney, MI (US); Kenneth Alfano, Canton, MI (US); Tejinder Singh Deo, Macomb, MI (US)

(72) Inventors: Robertson Davenport, Ann Arbor, MI (US); Michael Tarasev, Pinckney, MI (US); Kenneth Alfano, Canton, MI (US); Tejinder Singh Deo, Macomb, MI (US)

(73) Assignees: BLAZE MEDICAL DEVICES, LLC, Ann Arbor, MI (US); THE REGENTS OF THE UNIVERSITY OF MICHIGAN, Ann Arbor, MI (US)

(21) Appl. No.: 13/698,848

(22) PCT Filed: May 25, 2011
(86) PCT No.: PCT/US2011/037848

§ 371 Date: Feb. 15, 2013

Related U.S. Application Data
(60) Provisional application No. 61/347,831, filed on May 25, 2010.

(51) Int. Cl. A61J 1/10; A61J 1/18

(52) U.S. Cl. CPC A61J 1/10; A61J 1/18
USPC 604/404; 604/410

(57) ABSTRACT

A storage bag for containing biologic content having a first chamber operable to contain the biologic content, a second chamber separate from the first chamber, and a first fluidic seal system disposed between the first chamber and the second chamber. The first fluidic seal system is positionable between a first position retaining the biologic content in the first chamber and preventing the biologic content from entering the second chamber and a second position permitting at least a portion of the biologic content to flow from the first chamber to the second chamber.

### CROSS-REFERENCE TO RELATED APPLICATIONS

This application claims the benefit of U.S. Provisional Application No. 61/347,831, filed on May 25, 2010. The entire disclosure of the above application is incorporated herein by reference.

### FIELD

The present disclosure relates to medical devices and, more particularly, relates to medical specialty bags that facilitate sample extraction and unit subdivision, principally for sterile biologics, such as blood products.

### BACKGROUND

This section provides background information related to the present disclosure which is not necessarily prior art. Although the present discussion will focus primarily on use with blood, it should be recognized that alternative biologics and other liquids can be used and should be regarded as being within the scope of the present teachings.

Although blood transfusion entered medical practice at the beginning of the last century, it did not gain prominence in the field until methods for blood storage and preservation were developed. One of the critical items required for successful long-term blood storage is the blood bag. Modern blood storage bags are typically made of plasticized PVC, whose features make it the material of choice for many medical and specifically blood contact applications. Most importantly, it can be welded together (e.g. by high frequency), a feature which allows significant versatility in blood bag design and is also compatible with steam sterilization (up to 120° C.). Plasticized PVC also offers low toxicity, high strength, and flexibility—at both high and low temperatures.

Modern blood bags are typically designed to contain up to 0.5 L of blood product, and have one or more ports to access bag content. Such ports are typically sealed with a flexible membrane to isolate the contents and often by an additional tear-away cover to preserve the sterility of the membrane. These ports are for giving the transfusion to the patient, and cannot easily be re-sealed.

Another feature is one or more extended test-strips, often separated from the bag itself in a line of sealed, blood-containing segments. These segments are typically created at the initial processing stages, by dividing a single tube containing residual product into a series of smaller segments via a heat-sealing device. Such segments provide a convenient means to obtain small (about 0.5 ml per segment) samples of the unit's blood for certain types of testing (e.g. blood type) without the need to open or access the bag; a segment can be individually cut off as-needed.

Blood for transfusion is most often collected as whole blood (WB). Although sometimes transfused “as is,” whole blood is usually separated into its constituent components. Packed Red Blood Cells (RBC) and platelets are common examples of transfused blood components. The storage of such components can present various issues of clinical concern, which can lead to the need for testing of units while in storage and/or before use.

As an example of this, stored platelets are susceptible to bacterial contamination growth owing in part to their higher storage temperature. Between 1:2000 and 1:3000 platelet units are estimated to incur such contamination, and the American Association of Blood Banks (AABB) has recently encouraged greater measures to combat this problem. (For example, a novel platelet contamination test was recently launched by Verax Biomedical.)

Also occurring during storage, RBC quality can degrade (i.e. “storage lesion”) due to a number of morphological and biochemical changes in the RBC, which are presently roughly approximated by age, via a 42-day maximum shelf life and a first-in-first-out inventory protocol; however, actual quality levels and loss rates can exhibit much unit-to-unit variably and thus be only partly attributable to storage time. While yet to be validated, relevant RBC changes can potentially be predicted via in vitro testing aimed at the determination of relevant cell parameters (e.g. RBC membrane mechanical fragility, a test for which is under development by Blaze Medical Devices).

Although the separated test-strips are suitable for blood-typing and other such tests where the property in question is known to be identical to that in the actual bag, the preceding examples are different because the conditions in the bag may differ significantly from the separated test-strips. This principle is true for any property of any blood product whose condition or state can potentially change during storage.

Hence, blood product tests are likely among those that would benefit from being able to sterilely obtain a sample directly from the bag content itself.

In an attempt to use existing available segments to obtain representative samples, sometimes a procedure will be employed whereby the barrier/seal between a segment and bag is undone, then the segment's contents are moved back (e.g. with a rolling tool) into the bag, then the bag is “mixed” manually, and finally the segment is re-filled and re-sealed.

With current sampling from blood bags, there is one major alternative to using the attached segments. Samples of a unit's contents (˜10-15 ml) can be obtained without compromising sterility by using an FDA-approved procedure involving a fused-on/docked sample bag. In this procedure, a small sample pouch is attached to the RBC bag tubing via a sterile connection device (e.g., Terumo TSCD® Sterile Tubing Welder, Terumo Medical Corp.). A sample can then be transferred to the pouch, and the tubing heat-sealed and divided. Such methods, although feasible, can be cumbersome and time-consuming.

In another blood application, a need to obtain subsets of blood bag contents arises with the issue of splitting a single unit into two or more units. In some cases, a unit is partitioned into multiple sub-units, each of individually pre-determined size for later use; in other cases, it may be desirable to repeatedly obtain variable portions of a given unit over time on demand (e.g. for neonatal patients, who get transfused with fractional units, a single unit is often reserved for follow-up and “top-off” transfusions).

### SUMMARY

This section provides a general summary of the disclosure, and is not a comprehensive disclosure of its full scope or all of its features.

The present teachings provide internally-sterile medical storage bags, primarily for biologics and blood products, enabling the obtainment of samples for testing that are representative of product within the bag itself compared to pre-separated samples, more conveniently than existing means of obtaining representative samples.

Major applications include, for example, obtaining samples from RBC or platelet bags to test for bacterial contamination or storage lesion. Alternatively, the same design principles are also easily adapted to enable subdividing blood-product units whenever portions of such units are needed.

Further areas of applicability will become apparent from the description provided herein—such as bags for various other biologics and biopharmaceuticals suffering the same sterile-sampling challenges as RBCS or platelets. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 depicts a schematic illustration of a biologic storage bag according to the principles of the present teachings;

FIG. 2 depicts an enlarged cross-section of the biologic storage bag in FIG. 1 for obtaining samples of the bag content;

FIGS. 3a-3c depict examples of alternative embodiments;

FIG. 4 depicts a side-view example of the alternative embodiments depicted in FIG. 3c;

FIG. 5 depicts an example utilizing various multi-compartment chambers being sectioned off for selective capacity/volume control via similar mechanisms as those employed for bag-to-chamber connectivity;

FIG. 6 illustrates a cross-section of a single chamber subdivided with internal breakable walls; and

FIG. 7 illustrates a cross-section of a single chamber manufactured with excess material initially external-but-contiguous to the chamber material.

Corresponding reference numerals indicate corresponding parts throughout the several views of the drawings.

### DETAILED DESCRIPTION

Example embodiments will now be described more fully with reference to the accompanying drawings. Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms or adapted to many different purposes and that neither should be construed to limit the scope of the disclosure. The contents herein enable a wide range of uses and variations.

The terminology used herein is for the purpose of describing particular example embodiments only and is not intended to be limiting. As used herein, the singular forms “a”, “an” and “the” may be intended to include the plural forms as well, unless the context clearly indicates otherwise. The terms “comprises,” “comprising,” “including,” and “having,” are inclusive and therefore specify the presence of stated features, integers, steps, operations, elements, and/or components, but do not preclude the presence or addition of one or more other features, integers, steps, operations, elements, components, and/or groups thereof. The method steps, processes, and operations described herein are not to be construed as necessarily requiring their performance in the particular order discussed or illustrated, unless specifically identified as an order of performance. It is also to be understood that additional or alternative steps may be employed.

When an element or layer is referred to as being “on”, “engaged to”, “connected to” or “coupled to” another element or layer, it may be directly on, engaged, connected or coupled to the other element or layer, or intervening elements or layers may be present. In contrast, when an element is referred to as being “directly on,” “directly engaged to”, “directly connected to” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The present teachings provide multi-application means of obtaining subsets of biologic (primarily blood product) bag content without compromising sterility, penetrating the bag, or exposing bag contents to air. The term “bag” herein is intended to encompass all reasonably comparable notions of non-rigid containment, even if marketed as some similar alternative term (e.g. “pouch” or “biocontainer”); and, “unit” may refer to a bag and its product content together. The relevant functionality is achieved through the addition to the bag of pre-formed chambers/compartments that are initially empty and sealed-off from bag contents. These are likely (but not necessarily) made from the same material as the bag, incorporated in the same article of manufacture.

This description first addresses an application for obtaining samples of the bag content.

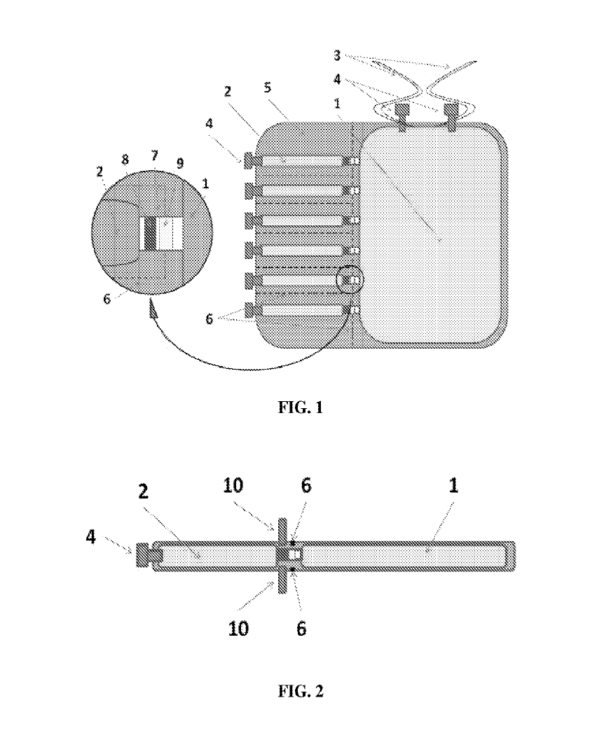

FIG. 1 is a schematic illustration of a biologic storage bag according to the principles of the present teachings (not to scale) having six exemplary small chambers/compartments of fixed and uniform capacity structurally integrated with the bag. Each chamber is connected to the interior of the bag, but begins free of any bag content or biologics, and flow from the bag is initially obstructed by at least one seal/membrane/barrier, which will be discussed in detail herein.

In the particular instance of FIG. 1, such an obstruction is being achieved through the use of a fused-seal susceptible to being pulled apart (such as those created by certain RF blood bag tube sealing devices), whereby two integrated pull-tabs (shown subsequently, in cross-sectional view) facilitate the opening of the fluidic connection (channel). (Note that notions of “fluidity” herein encompass any product states behaving with sufficiently fluid nature so as to render the inventive principles herein useful.) Alternative approaches for this feature include break-away/snap seals, valves, or other suitable means.

When a sample is desired, the seal on one of the chambers is opened/undone (after mixing the bag to ensure content homogeneity, in some embodiments), thus enabling flow from the bag into the chamber via, by non-limiting example, squeezing of the bag. After the chamber fills sufficiently, the connecting channel is sealed (e.g. thermal or RF seal(s), clamp(s), etc.). At this point, the chamber can be separated from the bag; the piece containing the chamber can be outlined by perforation facilitating easy separation from the bag. To separate at the channel, a cut may be required at the newly created seal (similarly to how current test-strips are removed); whether the cut is through a seal vs. between seals may depend on the particular re-sealing approach used. Each chamber can also be provided with its own sterile port for subsequent sample extraction.

For all figures, the numbers represent as follows: (1) a biologic storage bag according to the principles of the present teachings, which can contain product, biologics, or other liquid; (2) at least one chamber/compartment—initially free of bag content; (3) standard test strips/segments; (4) standard sterile access ports; (5) structural support material; (6) perforations or cutting outline; (7) fluidic channel connecting chamber to bag; (8) initial breakable seal/barrier blocking flow between bag and chamber or between chambers; (9) location of seal applied after flow to chamber or between chambers; (10) pull-tabs for aiding with initial-seal breakage; (11) internal breakable seal/barrier within a single chamber; and, (12) excess material available for expansion of a single chamber. It should be understood, however, that some of the aforementioned elements are optional and, thus, may not be found in every embodiment.

FIG. 2 is an enlarged side-view of the particular embodiment depicted in FIG. 1; note the pull-tabs protrude from the bag.

With respect to the bag-adjacent chambers, if desired these could be pre-filled with any additives used for sample preparation. In such cases, it may also be preferable to manufacture a one-way valve near the chamber-side of the channel or at the chamber entrance, in order to ensure the additive remains in the chamber (and does not contaminate the bag contents) throughout the filling process.

Notably, the diameter and shape of the channel can be tailored for particular applications. Relevant considerations include desire to control flow rate and/or turbulence which may be important, such as for preserving certain product properties (e.g. not activating platelets). Other considerations are ease of manufacturing, and compatibility with resealing procedures/devices. And channels need not be longitudinal, as any opening or pathway to allow flow could suffice.

With respect to the channel (re)sealing step, the principal objective is to ensure that neither the chamber nor the bag will be exposed to the environment after separation. Alternative means of implementing this seal upon the channel between the chamber and the bag (after the chamber fills) include the use of the devices currently used for sealing test strips/segments, adaptation(s) thereof, or a new/customized tool for similar function (hand-held or bench-top).

Presently, several devices exist for sealing off isolated test strips at points along bag tubing (e.g. “blood bag tube sealer”); use of these commercially-available devices for this invention can be aided by embodiments in which the channel between chamber and bag incorporates a “loop” protruding from the plane of the bag which can be readily inserted into (or accessed by) such devices for applying the seal. (Note that one of the figures illustrates an example of such a feature.)

As for adapting or customizing new sealing devices to accomplish the post-fill seal, principal aims include enhancing their access to the location of reseal on the channel, as well as the dimensions of the seal being applied (i.e. being compatible with the dimensions of the channel as configured, and convenient for subsequent separation via cutting, etc.). Also, such a seal may be a single-seal at which a cut can be made while preserving closure at both resultant ends created (as with current test-strips when removed), or two separate seals in parallel with a gap between at which to cut (or tear—if shallow, non-penetrative perforations are employed at the channel). Additionally, the cutting function could be incorporated into the sealing mechanism. As another approach, if chambers are manufactured with the one-way valve mentioned above, only a single seal would be needed which would be on the bag-side and no cut through the newly-created seal would be necessary. There are certain trade-off considerations to these various approaches: for example, a single-seal needs to be sufficiently strong and wide so as to be easily cut in the middle while maintaining the integrity of the seals on both newly-created ends.

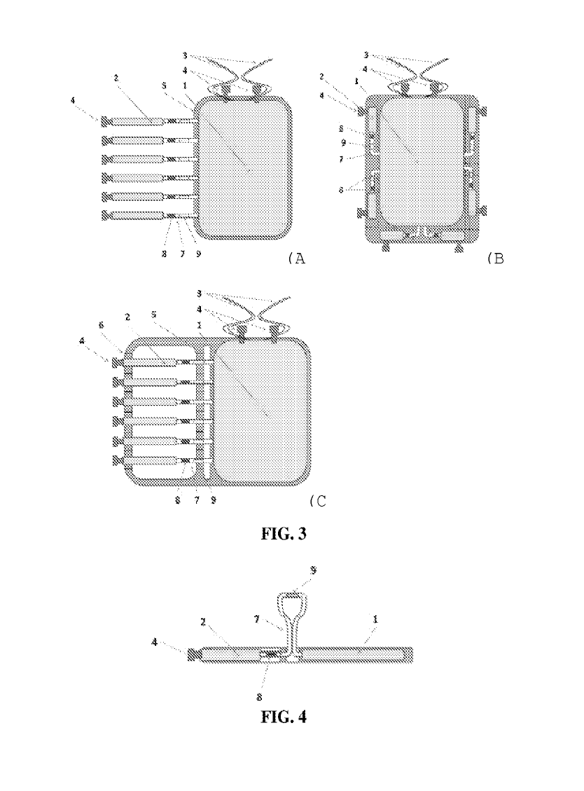

In addition to the various ways that pre and post sealing can be achieved, the overall configuration or arrangement of chambers can also take many forms. These variations include the number and size(s) of chambers, the extent of structural integration of the chambers with the bag, and the positioning of the chambers relative to the bag and each other. One purpose of such configurations is to facilitate the ease of access for the channel-sealing step. Another aim may include optimizing the surface for attaching bar codes or labels for sample tracking (note that integration of bag and chamber labels can provide an additional means of structural connectivity). FIGS. 3a-3c depict some examples of such alternative arrangements.

FIG. 4 depicts a side-view for an embodiment shown in FIG. 3c, depicting the “loop” protruding from the plane of the bag to facilitate use of current standard tube-sealing devices for the post-fill seal (as well as separation of the chamber from the bag).

The number of chambers to be incorporated into the design could be determined based on anticipated usage levels or requirements (e.g. number or frequency of tests to be performed on a product).

To control sample volume, one approach is simply to have graduated indications on the chambers to guide partial-filling at the time of use. But for certain applications, an ability to select or modify the capacity for collecting material from the bag may be desired. One way to control volume through total receiving capacity is simply to fill and remove more than one chamber at a time. Another enhancement of capacity and volume flexibility is possible by utilizing chambers of different sizes (e.g., 0.25 ml, 0.50 ml, 1 ml, etc.).

Also, having initially-blocked channels between chambers for on-demand fluidic interconnectivity among select subsets thereof (similar to the mechanism of the interface between chambers and the bag) can effectively create a multi-chamber (“meta-chamber”) single sample. Such a meta-chamber can thus be filled through any single channel between any constituent chamber and the bag, and the entire sample can later be extracted from a port of any constituent chamber. With the appropriate combination of chamber numbers, sizes, and/or interconnectivity, any desirable set of sample volumes can be achieved.

Besides creating meta-chambers out of multiple (otherwise-independent) chambers, custom volume selection can also be achieved by having some or all compartments (here with each such grouping having only a single channel collectively connecting the same to the bag) be selectively combinable on-demand to effect incremental capacity expansion (e.g. a honeycomb or grid-like structure). This could be accomplished by having channels connect select compartments of expedient size and/or positioning, or by other means including internal breakable “walls” (discussed below).

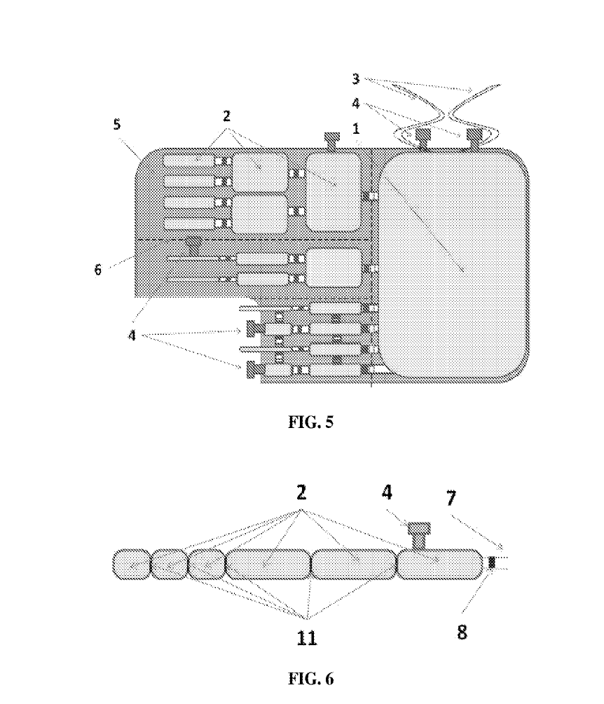

A hypothetical embodiment of assorted inter-connectable chambers of varying sizes, port usages, and interconnectivities is shown in FIG. 5. [Note that some of the interconnecting channels show just the initial/breakable seal, while others show a designated location for subsequent re-sealing as well (using the procedures noted above, e.g. heat-sealing, along with correspondingly facilitative features, e.g. protruding channel-loop).]

As indicated, another volume-selection approach is for multiple internal compartments within a chamber to be sectioned off via similar mechanisms as for the initial seals/membranes/barriers placed in channels, except here utilizing internal dividing “walls” instead of connecting “channels.” Hence a single chamber's capacity is determinable by how many of the initial barriers get undone (in order from bag outward, if implemented in serial/linear fashion). Note that unlike having channels between distinct chambers, where there is an option to include a designated place for subsequent re-seal, using an internal/breakable wall is not as conducive to re-segregation. FIG. 6 is an example illustration of a cross-section of a single chamber serially subdivided with internal breakable walls.

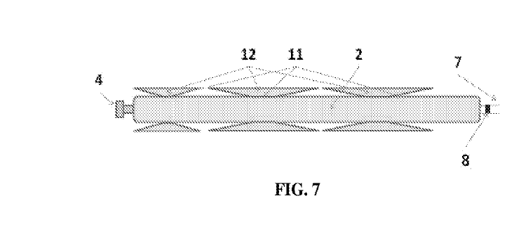

Yet another way to achieve intra-chamber volume selection is for them to be manufactured with excess material initially external-but-contiguous to the chamber material, and available to extend its dimensions on-demand, for example if the chamber is “tugged” longitudinally (analogous to “expandable luggage,” with its bunched-up initially-excess material secured via zipper). As with the previous example, multiple and varying such junctions are possible (again, in order from bag outward), and can be activated on-demand to determine a given chamber's total capacity for sampling. This approach in particular can allow high expansion ratios and extraction capacities (and is thus more likely suited to the unit-splitting/subdivision application discussed below), while preserving a relatively modest bag footprint. FIG. 7 is an example illustration of a cross-section of a single chamber utilizing this approach.

The preceding descriptions address applications for obtaining small, representative samples from a bag/unit for testing purposes. However, similar principles and approaches can also be utilized to achieve subdivision of units. The primary difference would be the likely larger capacity of the “chambers” (e.g. up to half the entire unit) for the unit-subdivision application. In some cases, a unit may be partitioned into multiple sub-units, each of individually pre-determined size for later use; in other cases, it may be desirable to repeatedly obtain variable portions of a given unit over time on-demand (for example, for neonatal transfusion patients who get transfused with fractional units, a single unit is often reserved for follow-up and “top-off’ transfusions). Various above-described features, functionalities, and/or derivations thereof can be combined to enable sample collection and/or unit subdivision.

A few notable advantages of this overall invention include, without limitation, the ease of obtaining representative samples of bag contents or unit subdivision/splitting while preserving sterility, repeatability of such obtainment and thus an enhanced possible number/frequency of testing, reduction of intermediary handling and thus of resultant contamination risk, potential reduction of product loss/waste (vs. with current fuse-on method for blood bags), the lack of residual material in test segment (vs. when rolling-back and refilling the initially pre-filled test segments on blood bags), avoidance of need to repeat roll-back and refill of test segments on blood bags to ensure mixing homogeneity, and the potential to perform sample collection and/or unit subdivision without oxygen contamination (for potential prospective anaerobic storage applications).

While these descriptions of the invention enable one of ordinary skill to make and use what are considered presently to be the best modes of every respective aspect thereof, those in the field will also understand and appreciate the existence of variations, combinations, and equivalents of the specific embodiments, methods, and/or examples used. Many variations in form and uses would occur to those skilled in the art. All such and other variations are intended to be within the scope and spirit of the invention. These may include, for example, omitting the frangible seal component (thus relying only on fluidic communication between chamber and bag), fashioning a sealable chamber directly from material originally constituting the main bag, or possibly varying the number of channels between the bag and any given chamber. (These approaches are not presently considered optimal, however.)

The foregoing description of the embodiments has been provided for purposes of illustration and description. It is not intended to be exhaustive or to limit the invention. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the invention, and all such modifications apparent to those in relevant fields are intended to be included within the scope of the invention. These may include, for example, adapting the principles herein of obtaining representative samples/aliquots without exposing bag contents to other blood products not focused here (such as plasma), or other blood-related material (such as hemopoetic stem cells), or any other biologic or drug material having a need for representative samples or aliquots while preserving sterility of bag contents. Likewise, bags involved may be intended for collecting, storing, manufacturing, culturing, processing, and/or administering any given product. Note that bag or partition sizes may vary widely, ranging from milliliters to hectoliters depending upon the application, but the principles are scalable and remain similar. Moreover, “product” encompasses non-commercial substances (such as biological samples taken from patients) that may be contained in bags.

What is claimed is:

1. A storage bag for containing biologic content, said storage bag comprising:
a first chamber operable to contain the biologic content;
a second chamber separate from said first chamber;
a first fluidic seal system disposed between said first chamber and said second chamber, said first fluidic seal system being positionable between a first position retaining the biologic content in said first chamber and preventing the biologic content from entering the second chamber and a second position permitting at least a portion of the biologic content to flow from said first chamber to said second chamber.

2. The storage bag according to claim 1, further comprising:
a third chamber separate from said first chamber and said second chamber;
a second fluidic seal system disposed between said first chamber and said third chamber, said second fluidic seal system being positionable between a first position retaining the biologic content in said first chamber and preventing the biologic content from entering the third chamber and a second position permitting at least a portion of the biologic content to flow from said first chamber to said third chamber.

3. The storage bag according to claim 1, further comprising:
a third chamber separate from said first chamber and said second chamber;
a second fluidic seal system disposed between said second chamber and said third chamber, said second fluidic seal system being positionable between a first position retaining the at least a portion of biologic content in said second chamber and preventing the at least a portion of biologic content from entering the third chamber and a second position permitting at least a second portion of the biologic content to flow from said second chamber to said third chamber.

4. The storage bag according to claim 1, further comprising:
a pharmaceutical additive disposed within said second chamber, said pharmaceutical additive being separate from the biologic content when the first fluidic seal system is in said first position.

5. The storage bag according to claim 1, further comprising:
graduated indicia disposed on said second chamber, said graduated indicia being representative of a volume within said second chamber.

6. The storage bag according to claim 1 wherein said second chamber is separable from said first chamber while maintaining said at least a portion of the biologic content therein.

7. The storage bag according to claim 6 wherein at least a portion of a boundary between said second chamber and said first chamber is perforated to permit said separation.

8. The storage bag according to claim 1 wherein said first fluidic seal system generally prevents said portion of the biologic content within said second chamber to flow to said first chamber.

9. The storage bag according to claim 1 wherein said first fluidic seal system comprises a frangible portion.

10. The storage bag according to claim 1 wherein said first fluidic seal system is configured to prevent exposure of the biologic content to external air.

11. The storage bag according to claim 1 wherein said first fluidic seal system is a breakable system such that said first position is an unbroken position and said second position is a broken position.

12. The storage bag according to claim 1 wherein said first fluidic seal system comprises at least one internal wall disposed between said first chamber and said second chamber, said at least one internal wall being breakable such that said first position is an unbroken position and said second position is a broken position.

13. The storage bag according to claim 1 wherein said first fluidic seal system comprises a one-way valve.

14. The storage bag according to claim 1 wherein said first fluidic seal system is sealable using a thermal device.

15. The storage bag according to claim 1 wherein said first fluidic seal system is sealable using an ultrasonic welder.

16. The storage bag according to claim 1 wherein said first fluidic seal system is mechanically movable between the first position and the second position.

17. The storage bag according to claim 1 wherein said first fluidic seal system comprises an exposed channel sealable using a tube-sealing device, said exposed channel having a portion protruding or otherwise accessible by at least one type of tube-sealing device.

18. A method of sampling or aliquotting contents of a bag, said method comprising:
transferring a representative first portion of bag contents from a first enclosure to a second enclosure;
creating a seal or barrier between said first portion of bag contents and the remaining portion of bag contents in said first enclosure; and
accessing said first portion of bag contents in said second enclosure without accessing said remaining portion of bag contents in said first enclosure.

19. The method according to claim 18, further comprising:
separating said second enclosure from said first enclosure without exposing said first portion of bag contents and said remaining portion of bag contents to external air.

20. The method according to claim 18, further comprising:
transferring a subset portion of said representative first portion of bag contents from said second enclosure to a third enclosure.
